(19) United States
(12) Patent Application Publication
(10) Pub. No.: US 2016/0285819 A1
(43) Pub. Date: Sep. 29, 2016

(54) SHARING AND CONTROLLING ELECTRONIC DEVICES LOCATED AT REMOTE LOCATIONS USING XMPP SERVER

(71) Applicant: HCL Technologies Limited, Noida (IN)

(72) Inventors: Sanjay Kumar YADAVA, Noida (IN); Parveen Kumar JAIN, Noida (IN); S U M Prasad DHANYAMRAJU, Hyderabad (IN)

(21) Appl. No.: 15/059,810

(22) Filed: Mar. 3, 2016

(30) Foreign Application Priority Data
Mar. 25, 2015 (IN) 833/DEL/2015

(51) Int. Cl. H04L 12/58; G06F 21/84; H04L 29/06

(52) U.S. Cl. CPC H04L 51/36; H04L 65/1069; H04L 51/046; H04L 67/42; H04L 63/08; H04L 63/02; G06F 21/84

(57) ABSTRACT

Disclosed is Extensible Messaging and Presence Protocol (XMPP) server for sharing and controlling electronic devices located at remote locations. XMPP server receives request notification from client device for establishing communication with host device. XMPP server authenticates client device and host device using XMPP credentials and sends request notification to host device and receive an acceptance notification from the host device for establishing communication with the client device. XMPP server establishes bidirectional secured communication channel between the client device and the host device using an XMPP protocol or a network protocol, over a secured layer protocol and facilitates communication between the client device and the host device over the bidirectional secured communication channel. Client device and host device are connected under secured network and restricted to access each other through firewall restricted boundaries.

### CROSS-REFERENCE TO RELATED APPLICATIONS AND PRIORITY

The present application claims benefit from Indian Complete Patent Application No. 833/DEL/2015, filed on Mar. 25, 2015, the entirety of which is hereby incorporated by reference.

### TECHNICAL FIELD

The present subject matter described herein, in general, relates to sharing and controlling electronic devices located at remote locations, and more particularly to sharing and controlling electronic devices protected with network security provisions, having varied remote connectivity protocols, and located at remote locations.

### BACKGROUND

Remote sharing and controlling enables users to access electronic devices located at distant locations through a network or internet. Key challenges in remote sharing and controlling of the electronic devices are the ability to provide remote connectivity when the electronic devices located at distant locations are protected with high network security provisions or layered in firewalls. Further, there may be a requirement of varied remote connectivity protocols like Remote Desktop Protocol (RDP), Virtual Network Computing (VNC) and the like by the users for remote sharing and controlling. Currently, a variety of tools having use of Internet Protocol Security (IPSec) virtual private network (VPN), Secure Sockets Layer (SSL) VPN are available for remote sharing and controlling of the electronic devices. However the existing tools providing remote connectivity cannot access the electronic devices under high security of network and firewalls. Existing tools either depend upon IP address or unique name of host device for remote controlling purpose, if client and host device are not visible or accessible for each other, then the existing tools fail to provide remote connectivity using Internet Protocol Security (IPSec) virtual private network (VPN), Secure Sockets Layer (SSL) VPN protocols. Further, Internet Protocol Security (IPSec) virtual private network (VPN), Secure Sockets Layer (SSL) VPN protocols have complex format of request and response messages, and follow many steps and lengthy processes during remote communication initialization and controlling session. Hence the existing tools pose many challenges in accessing the electronic devices located at remote locations and protected under high security of network, or firewalls. Further the existing tools are platform dependent, and controlling devices used for establishing remote connections run on different operating systems, and the controlling devices are very tedious to operate. Most of the existing tools do not support work on a variety of operating systems. For example RDP is tightly coupled with Windows™ and hence RDP™ client cannot run and work on any other type of Operating systems like Linux™, Mac™ OS. Further, while considering mobility of the users outside the network, the remote sharing and controlling of the electronic devices becomes more challenging.

In one scenario, when client and host electronic devices are not directly accessible to each other, the client and host electronic devices do not have any public IP address, and thus the client and host electronic devices are not directly visible to external world over the internet, then directly accessing and controlling the client and host electronic devices is impossible. Hence, in that scenario the currently available tools fail to provide remote sharing and controlling of the electronic devices.

### SUMMARY

This summary is provided to introduce aspects related to systems and methods for sharing and controlling electronic devices located at remote locations is disclosed, and the aspects are further described below in the detailed description. This summary is not intended for use in determining or limiting the scope of the claimed subject matter.

In one implementation, a method for sharing and controlling electronic devices located at remote locations is disclosed. The method includes receiving, by an Extensible Messaging and Presence Protocol (XMPP) server, a request notification from a client device, for establishing communication with a host device. The method further includes authenticating, by the XMPP server, the client device and the host device, by using one or more XMPP credentials and sending, by the XMPP server, the request notification of the client device to the host device, based upon the authentication of the client device and the host device. The method further includes receiving, by the XMPP server, an acceptance notification from the host device for establishing the communication with the client device. The method further includes sending, by the XMPP server, the acceptance notification to the client device. The method further includes establishing, by the XMPP server, a bidirectional secured communication channel between the client device and the host device, using an Extensible Messaging and Presence Protocol (XMPP) or a network protocol, over a secured layer protocol; and facilitating, by the XMPP server, the communication between the client device and the host device over the bidirectional secured communication channel.

In one implementation, an Extensible Messaging and Presence Protocol (XMPP) server (102) for sharing and controlling electronic devices located at remote locations is disclosed. The XMPP server includes a processor (108) and a memory (112) coupled to the processor (108). The processor (108) is capable of executing programmed instructions stored in the memory (112) to receive a request notification from a client device (104), for establishing communication with a host device (105). The processor authenticates the client device (104) and a host device (105), using one or more XMPP credentials. The processor further sends the request notification of the client device (104) to the host device (105) based upon the authentication of the client device (104) and the host device (105). The processor further receives an acceptance notification from the host device (105) for establishing the communication with the client device (104). The processor further sends the acceptance notification to the client device (104). The processor further establishes a bidirectional secured communication channel between the client device (104) and the host device (105), using an XMPP protocol or a network protocol, over a secured layer protocol. The processor further facilitates the communication between the client device (104) and the host device (105) over the bidirectional secured communication channel.

In one implementation, a client device (104) communicating with a host device (105) located at remote location, through an Extensible Messaging and Presence Protocol XMPP server (102) is disclosed. The client device (104) includes a client processor (140) and a client memory (142) coupled to the client processor (140). The client processor (140) is capable of executing programmed instructions stored in the client memory (142) to send, a request notification, to the XMPP server (102) for establishing communication with the host device (105). The client processor (140) receives an acceptance notification from the XMPP server (102) for establishing the communication with the host device (105), by using a client message handler 146. The client processor (140) further communicates with the host device (105) over a bidirectional secured communication channel established with the host device (105), using an XMPP protocol or a network protocol, over a secured layer protocol, by the XMPP server (102).

In one implementation, a host device (105) communicating with a client device (104) located at remote location, through an Extensible Messaging and Presence Protocol XMPP server (102) is disclosed. The host device (105) includes a host processor (150) and a host memory (152) coupled to the host processor (150). The host processor (150) is capable of executing programmed instructions stored in the host memory (152) to receive a request notification from the XMPP server (102) for establishing communication with the client device (104), by using a host message handler 156. The host processor (150) further sends an acceptance notification to the XMPP server (102) for establishing the communication with the client device (104). The host processor (150) further communicates with the client device (104) over a bidirectional secured communication channel established with the host device (105), using an XMPP protocol or a network protocol, over a secured layer protocol, by the XMPP server (102).

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of an Extensible Messaging and Presence Protocol (XMPP) server for sharing and controlling electronic devices located at remote locations, in accordance with an embodiment of the present subject matter.

FIG. 2 illustrates a client device and a host device, in accordance with an embodiment of the present subject matter.

FIG. 3 illustrates a functional architecture of the XMPP server for sharing and controlling the electronic devices located at remote locations, in accordance with an embodiment of the present subject matter.

FIG. 4 illustrates working of the XMPP server for sharing and controlling the electronic devices located at remote locations, in accordance with an embodiment of the present subject matter.

FIGS. 5A and 5B illustrate communications happening between the client device and the host device through XMPP server, in accordance with an embodiment of the present subject matter.

FIG. 6 illustrates a method for sharing and controlling electronic devices located at remote locations, in accordance with an embodiment of the present subject matter.

### DETAILED DESCRIPTION

Systems and methods for sharing and controlling electronic devices located at remote locations are described. The electronic devices located at the remote locations may be connected via an Extensible Messaging and Presence Protocol (XMPP) server as a middleware. The present subject matter discloses an effective and efficient mechanism for sharing and controlling the electronic devices located at the remote locations over XMPP protocol using messages. In order to share and control electronic devices such as a client device and a host device, a request notification may be received from the client device, by the XMPP server, for establishing a communication channel with the host device. Post receiving the request notification, the XMPP server may authenticate the client device and the host device by using XMPP credentials. Further, the XMPP server may send the request notification of the client device to the host device, based upon the authentication of the client device and the host device. Post sending the request notification to the host device, the XMPP server may receive an acceptance notification from the host device for establishing the communication with the client device. Post receiving the acceptance notification from the host device, the XMPP server may share the acceptance notification with the client device. Further, the XMPP server may set a bidirectional secured communication channel between the client device and the host device, using one of an XMPP protocol or a network protocol, over a secured layer protocol. Post setting the bidirectional secured communication channel between the client device and the host device, the XMPP server may facilitate the communication between the client device and the host device over the bidirectional secured communication channel.

While aspects of described systems and methods for sharing and controlling electronic devices located at remote locations may be implemented in any number of different computing systems, environments, and/or configurations, the embodiments are described in the context of the following exemplary system.

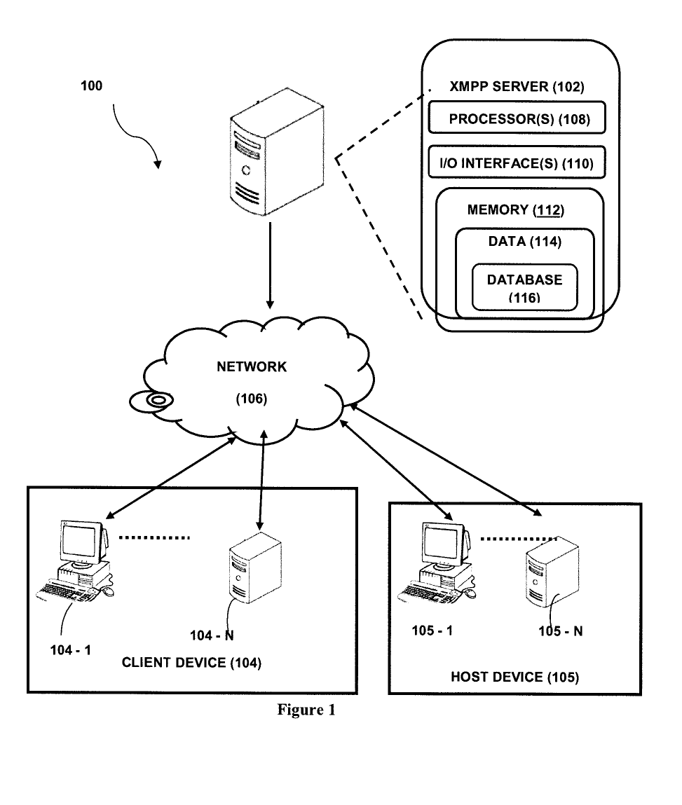

Referring now to FIG. 1, a network implementation 100 of an Extensible Messaging and Presence Protocol (XMPP) server (102) for sharing and controlling electronic devices, located at remote locations, is illustrated, in accordance with an embodiment of the present subject matter. In one embodiment, the XMPP server (102) may provide sharing and controlling the electronic devices located at remote locations. In one embodiment, the XMPP server 102 may provide sharing and controlling the electronic devices, located at remote locations, using an XMPP protocol over a Transport Layer Security (TLS) or a Secure Sockets Layer (SSL) protocol by means of a message handler. In one embodiment, in order to provide sharing and controlling the electronic devices, located at remote locations, the XMPP server (102) may receive a request notification from a client device 104 for establishing communication with a host device 105. Post receiving the request notification from the client device 104, the XMPP server 102 may authenticate the client device 104 and the host device 105, using one or more XMPP credentials. The XMPP server 102 may send the request notification of the client device 104 to the host device 105, based upon the authentication of the client device and the host device. The XMPP server 102 may receive an acceptance notification from the host device 105 for the communication with the client device 104. Post receiving the acceptance notification from the host device 105, the XMPP server 102 may share the acceptance notification with the client device 104. Post sharing the acceptance notification with the client device 104, the XMPP server 102 may set a bidirectional secured communication channel between the client device 104 and the host device 105, using an XMPP protocol or a network protocol, over a secured layer protocol. Post setting the bidirectional secured communication channel between the client device 104 and the host device 105, the XMPP server 102 may facilitate the communication between the client device 104 and the host device 105 over the bidirectional secured communication channel.

Although the present subject matter is explained considering that the XMPP server 102 provides sharing and controlling electronic devices located at remote locations, it may be understood that the sharing and controlling electronic devices located at remote locations may also be facilitated by a variety of computing systems, such as a laptop computer, a desktop computer, a notebook, a workstation, a mainframe computer, a network server, and the like. In one implementation, the XMPP server 102 may be implemented in a cloud-based environment. It will be understood that the XMPP server 102 may be accessed by multiple users through one or more client devices 104-1, 104-N, collectively referred to as the client device 104 hereinafter, or applications residing on the client device 104. Examples of the client device 104 may include, but are not limited to, a portable computer, a personal digital assistant, a handheld device, mobile, tablet, laptop, a workstation, embedded devices, televisions, servers, different type of computers comprising super computer, mainframe computer, minicomputer, microcomputer and the like. The XMPP server 102 may also be accessed by multiple users through one or more host devices 105-1, 105-N, collectively referred to as host device 105 hereinafter, or applications residing on the host device 105. Examples of the host device 105 may include, but are not limited to, a portable computer, a personal digital assistant, a handheld device, laptop, mobile, tablet, a workstation, embedded devices, televisions, servers, different type of computers comprising super computer, mainframe computer, minicomputer, microcomputer and the like. The client device 104 and the host device 105 may be communicatively coupled to the XMPP server 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Extensible Messaging and Presence Protocol (XMPP), Hypertext Transfer Protocol (HTTP), Transmission Control Protocol/Internet Protocol (TCP/IP), Wireless Application Protocol (WAP), Remote Desktop Protocol (RDP), Virtual Network Computing (VNC), Secure File Transfer Protocol, Secure Socket Layer, Transport Layer Security, and the like, to communicate with one another. Further the network 106 may include a variety of network devices, including routers, bridges, servers, computing devices, storage devices, and the like.

Referring now to FIG. 1, the XMPP server 102 is illustrated in accordance with an embodiment of the present subject matter. In one embodiment, the XMPP server 102 is having at least one processor 108, an input/output (I/O) interface 110, and a memory 112. The at least one processor 108 may be implemented as one or more microprocessors, microcomputers, microcontrollers, digital signal processors, central processing units, state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The XMPP server 102 may interact with the client device 104 and the host device 105 as shown in FIG. 1. Further, the XMPP server 102 may also communicate with other computing devices, such as web servers and external data servers (not shown). The I/O interface 110 may facilitate the XMPP server 102 to communicate with other computing devices. The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 112 may include the programmed instructions and data 114.

The data 114, amongst other things, serves as a repository for storing data processed, received, and generated by execution of the programmed instructions. The data 114 may also include a system database 116.

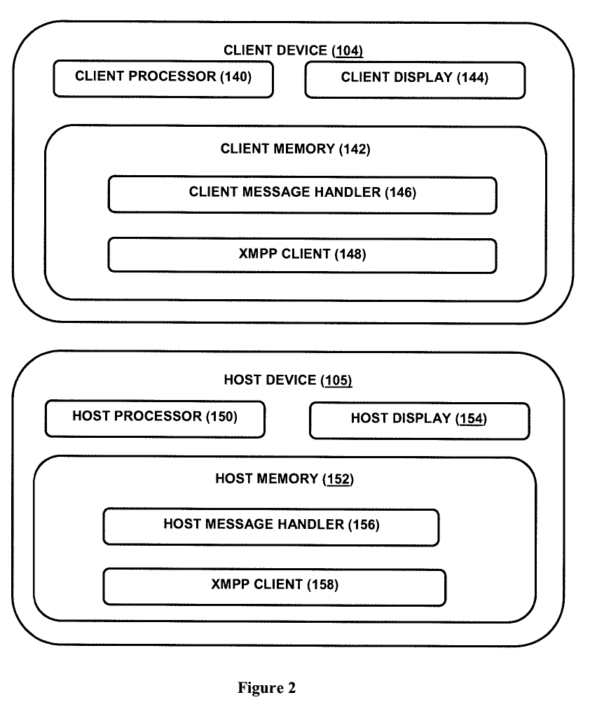

Referring now to FIG. 2, a client device 104 is illustrated in accordance with an exemplary embodiment of the present disclosure. In one embodiment, the client device 104 may include one or more client processors 140, one or more client memories 142, and a client display 144. The one or more client processors 140 may be implemented as one or more microprocessors, microcomputers, microcontrollers, digital signal processors, central processing units, state machines, logic circuitries, and/or any devices that manipulate signals based on operational instructions. Among other capabilities, the one or more client processors 140 are configured to fetch and execute computer-readable instructions stored in the one or more client memories 142. The one or more client memories 142 may further comprise a client message handler 146 and an XMPP client 148.

The one or more client memories 142 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The client display 144 may include a LCD display, a LED display and other displays that are obvious to persons skilled in the art.

Referring now to FIG. 2, the host device 105 is illustrated in accordance with an embodiment of the present disclosure. In one embodiment, the host device 105 may include one or more host processors 150, one or more host memories 152, and a host display 154. The one or more host processors 150 may be implemented as one or more microprocessors, microcomputers, microcontrollers, digital signal processors, central processing units, state machines, logic circuitries, and/or any devices that manipulate signals based on operational instructions. Among other capabilities, the one or more host processors 150 are configured to fetch and execute computer-readable instructions stored in the one or more host memories 152. The one or more host memories 152 may further comprise a host message handler 156 and an XMPP client 158.

The one or more host memories 152 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The display 154 may include a LCD display, a LED display and other displays that are obvious to persons skilled in the art.

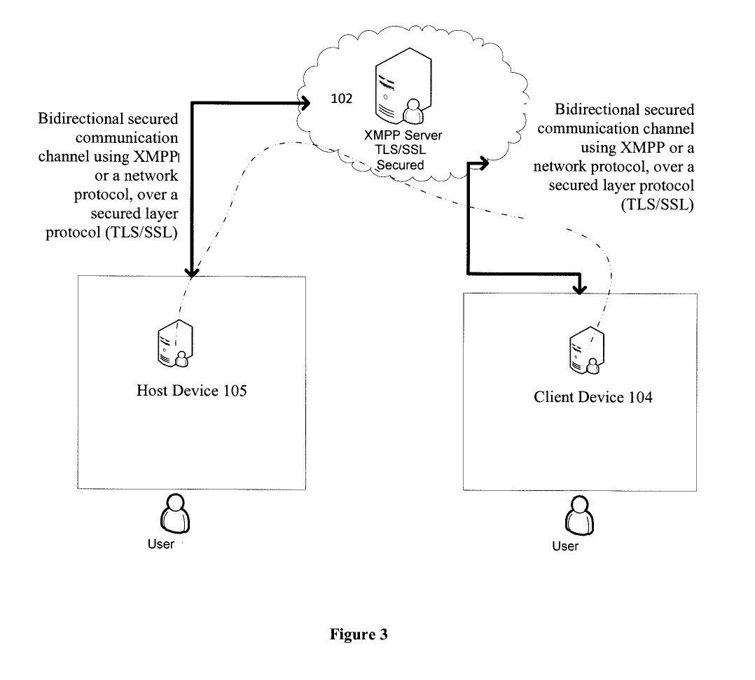

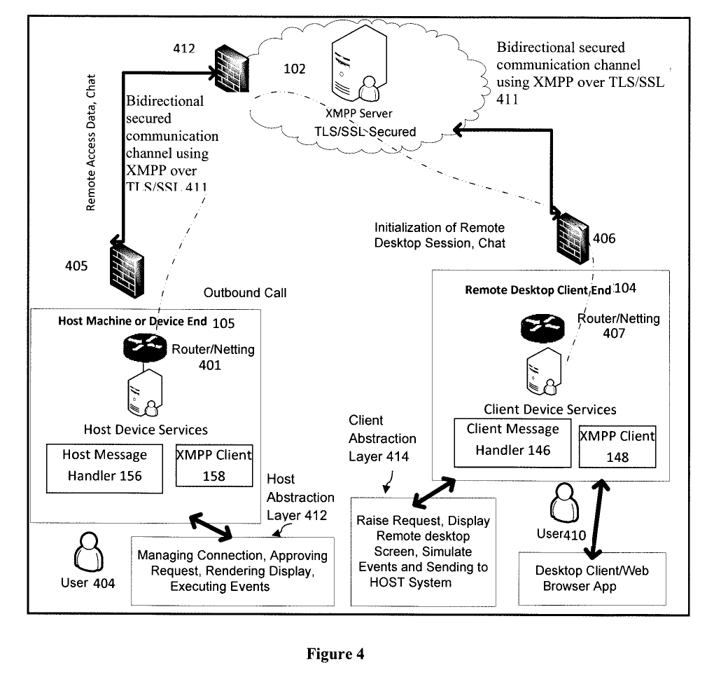

According to an embodiment, referring to FIG. 3 and FIG. 4, working of the XMPP server 102 is explained below. In one implementation, at first, the client device 104 accesses the XMPP server 102. The user may register using the client device 104 in order to access the XMPP server 102. In one implementation, the XMPP server 102 may be used for sharing and controlling electronic devices located at remote locations. FIG. 3 illustrates functional architecture of the XMPP server 102 for sharing and controlling electronic devices located at remote locations, in accordance with an embodiment of the present subject matter. FIG. 4 illustrates working of the XMPP server 102 for sharing and controlling the electronic devices located at remote locations, in accordance with an embodiment of the present subject matter. The XMPP server 102 may be located at any public network. The XMPP server 102 may be located in a cloud or any other network.

The electronic devices may be one or more client devices (104) and one or more host devices (105). The electronic devices may comprise a variety of electronic devices. The electronic devices may comprise a variety of computing systems, such as a laptop computer, a desktop computer, a notebook, a workstation, a mainframe computer, a network server, a mobile device, a portable computer, a tablet, and the like. The electronic devices may be any electronic device known to a person skilled in the art.

In one embodiment, referring to FIG. 3, in order to share and control electronic devices located at remote locations, the client device 104 may register at the XMPP server 102 and the XMPP server 102 may provide the client device 104 a first identification number as a XMPP credential. Further, the host device 105 may register the XMPP server 102 and the XMPP server 102 may provide the host device 105 a second identification number as the XMPP credential. In another example, the client device 104 and the host device 105 may register the XMPP server 102 using an Internet Protocol (IP) address.

In one embodiment, as the client device 104 may communicate and access the host device 105, the client device 104 may send a request notification to the XMPP server 102 for establishing communication with the host device 105. Further, in order to share and control electronic devices located at remote locations, the XMPP server 102 may receive the request notification from the client device 104, for establishing communication with the host device 105. In one embodiment, the client device 104 and the host device 105 may be connected under a secured network. The client device 104 and the host device 105 may be restricted for access to each other through firewall restricted boundaries. In another embodiment, the client device 104 and the host device 105 may not having a public IP address or a public identification number. Hence the client device 104 and the host device 105 may be invisible to external devices.

Post receiving the request notification, the XMPP server 102 may authenticate the client device 104 by using one or more XMPP credentials. The one or more XMPP credentials may comprise an internal identification number or Internet Protocol (IP) address. In one example, the one or more XMPP credentials may comprise the first identification number so provided by the XMPP server 102 to the client device 104. If the XMPP server 102 identifies the client device 104 as an authentic device, the XMPP server 102 may allow the client device 104 for further communication.

Post authenticating the client device 104, the XMPP server 102 may authenticate the host device 105 using the one or more XMPP credentials. Post authenticating the host device 105, the XMPP server 102 may send the request notification of the client device 104 to the host device 105, based upon the authentication of the client device 104 and the host device 105. The client device 104 and the host device may be identified as authentic. Post receiving the request notification of the client device 104, the host device 105 may accept the request notification of the client device 104 for establishing the communication with the client device 104. Post accepting the request notification of the client device 104, the host device 105 may send an acceptance notification to the XMPP server 102 for establishing the communication with the client device 104.

Post receiving the acceptance notification, the XMPP server 102 may send the acceptance notification to the client device 104. Further, the XMPP server 102 may establish a bidirectional secured communication channel between the client device 104 and the host device 105, using an XMPP protocol or a network protocol, over a secured layer protocol. The network protocol may be selected from a Transmission Control Protocol (TCP) or an Internet Protocol (IP). The secured layer protocol may be selected from a Transport Layer Security (TLS) or a Secure Sockets Layer (SSL) protocol.

Post establishing the bidirectional secured communication channel between the client device 104 and the host device 105, the XMPP server 102 may facilitate the communication between the client device 104 and the host device 105 over the bidirectional secured communication channel The XMPP server 102 may facilitate the communication between the client device 104 and the host device 105 using the one or more XMPP credentials. The one or more XMPP credentials may comprise the internal identification number or the Internet Protocol (IP) address. The XMPP server 102 may establish the bidirectional secured communication channel by using a client abstraction layer and a host abstraction layer, to load plug-ins for the XMPP protocol. The client abstraction layer and the host abstraction layer may handle rendering remote display and transporting an event for the client device 104 and the host device 105 respectively.

The XMPP server 102 plays a significant role in establishing the bidirectional secured communication channel between the client device 104 and the host device 105, when both the client device 104 and the host device 105 are under secured networks and firewalls restricted boundaries, and the client device 104 and the host device 105 are not directly reachable or accessible to each other, and the client device 104 and the host device 105 don't have any public IP address and thus the client device 104 and the host device 105 are not directly visible to external world over the internet, in that scenarios accessing and controlling the client device 104 and the host device 105 is not possible. So XMPP server 102 is working as a middleware between the client device 104 and the host device 105 and provides a way to overcome communication challenges, and control the client device 104 and the host device 105 located remotely anywhere in the globe under any network.

The communication between the client device 104 and the host device 105 is executed via the XMPP server 102 over the bidirectional secured communication channel, wherein the client device 104 and the host device 105 may be located inside a network security provision and/or a firewall blockage. The communication happens through the bidirectional secured communication channel in form of encoded and compressed data. Referring to FIG. 3 and FIG. 4, a process of sharing, accessing and controlling the electronic devices or systems located at remote locations using XMPP server 102 is described in accordance with an exemplary embodiment of the present disclosure.

According to an embodiment, a client device (104) communicating with a host device (105) located at remote locations, through an Extensible Messaging and Presence Protocol XMPP server (102) is described. The client device 104 sends, a request notification, to the XMPP server (102) for establishing communication with the host device (105), by using a client message handler (146). The client device receives an acceptance notification from the XMPP server (102) for establishing the communication with the host device (105), by using the client message handler 146. The communication may be remote communication. The remote communication may be taking remote control of another device. Post receiving the acceptance notification from the XMPP server (102), the client device 104 communicates with the host device (105) over a bidirectional secured communication channel established with the host device (105), using an XMPP protocol or a network protocol, over a secured layer protocol, by the XMPP server (102). The network protocol may be selected from Transmission a Control Protocol (TCP) or an Internet Protocol (IP). The secured layer protocol is selected from a Transport Layer Security (TLS) or a Secure Sockets Layer (SSL) protocol. The client device 104 and host device 105 may be connected under secured network, and the client device 104 and host device 105 may be restricted to access each other through firewall restricted boundaries. The client device may receive a screen from the host device (105) over the bidirectional secured communication channel. The client device 104 may decode the screen and render the screen on a user interface. The client device 104 may further receive a change in the screen from the host device over the bidirectional secured communication channel. The client device 104 may further decode the change in the screen and merge the change in the screen to generate an updated screen. Post updating the screen, the client device 104 may render the updated screen on the user interface of the client device. The client device 104 may further capture and simulate, at least one of one or more control events and/or clipboard and the like. Post capturing and simulating the at least one of one or more control events and/or clipboard and the like, the client device 104 may encode the at least one of one or more control events and/or clipboard and the like, and the client device 104 may further send encoded the at least one of one or more control events and clipboard to the host device (105) over the bidirectional secured communication channel.

According to an embodiment, a host device (105) communicating with a client device (104) located at remote location, through an Extensible Messaging and Presence Protocol XMPP server (102) is described. The host device 105 may receive a request notification from the XMPP server (102) for establishing communication with the client device (104), by using a host message handler (156). Post receiving the request notification, the host device 105 may send an acceptance notification to the XMPP server (102) for establishing the communication with the client device (104), by using the host message handler (156). Post sending the acceptance notification, the host device 105 may further communicate with the client device (104) over a bidirectional secured communication channel established with the host device (105), using an XMPP protocol or a network protocol, over a secured layer protocol, by the XMPP server (102). The network protocol may be selected from Transmission a Control Protocol (TCP) or an Internet Protocol (IP). The secured layer protocol may be selected from a Transport Layer Security (TLS) or a Secure Sockets Layer (SSL) protocol.

While communicating with the client device 104, the host device 105 may capture a screen of the host device itself and encode captured screen. The host device 105 may further send the encoded screen to the client device 104 over the bidirectional secured communication channel. Post sending the encoded screen to the client device 104, the host device 105 may capture changes in the screen and encode the changes in the screen. Post encoding the changes in the screen, the host device 105 may send encoded changes in the screen to the client device 104 over the bidirectional secured communication channel The host device 105 may receive encoded at least one of one or more control events and/or clipboard from the client device 104 over the bidirectional secured communication channel Post receiving the encoded at least one of one or more control events and/or clipboard from the client device 104, the host device 105 may further execute received at least one of one or more control events and/or clipboard at the host device.

Referring to FIG. 3, an XMPP server 102, a client device 104 and host device 105 may be located at distant locations. In one embodiment, end users may be accessing and taking control of the client device 104 and the host device 105. The XMPP server 102 may be used as a middleware during a communication between the client device 104 and the host device 105. The XMPP server 102 may be used for enabling the two way remote communication between the client device 104 and the host device 105. The communication may be a two way remote communication. Once the bidirectional secured communication channel is established between the client device 104 and the host device 105, by the XMPP server 102, the communication may be initiated between the client device 104 and the host device 105. Once the request notification is accepted from the host device 105, screen display from the host device 105 to the client device 104 may be transmitted through the bidirectional secured communication channel. Further, control events, and/or clipboards simulated from the client device 104 are transmitted through the bidirectional secured communication channel to the XMPP server 102. The bidirectional secured communication channel overcomes firewall, network boundary security restrictions and challenges, which most of existing remote access tools don't support for establishing remote sessions in secured environments. The XMPP server 102 may use custom protocol for the communication or may use any of pre-existing protocols for establishing bidirectional secured communication channel over the network.

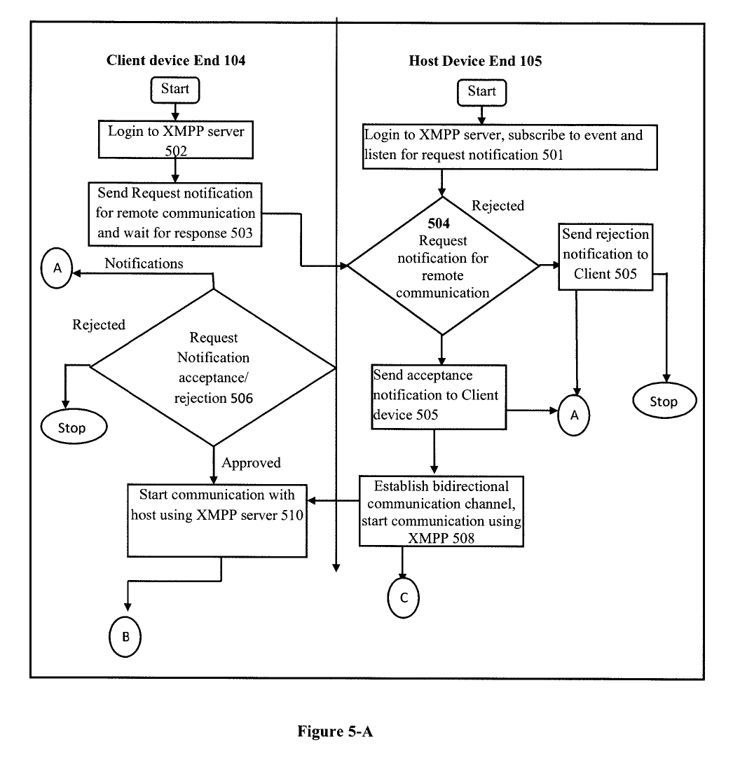

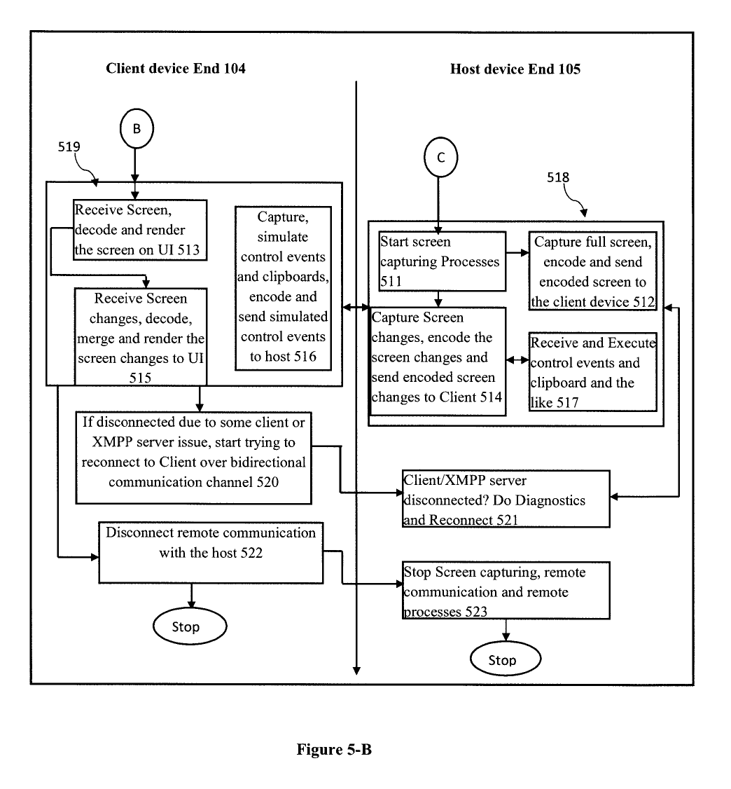

According to an exemplary embodiment, FIGS. 5A and 5B illustrate communicationsn happening between the client device 104 and the host device 105 through XMPP server (102). According to an exemplary embodiment, referring to FIG. 4 and FIG. 5-A and FIG. 5-B, the communication happening between the client device 104 and the host device 105 through XMPP server (102), is described below. The FIG. 4 depicts a host side firewall 405, a client side firewall 406, and a XMPP server level firewall 412, a router/netting device at client 407 and a router/netting device at host end 401. The router/netting device at client 407 and the router/netting device at host end 401 causes network accessibility challenges for both the client device 104 and the host device 105. A XMPP client 148 at the client device 104 is used for connecting and communicating with the XMPP server 102 and the communication starts from the client side 104 through an outbound call. The XMPP client 148 at client device and a XMPP client 158 at host device communicate with the XMPP server 102, the XMPP client 158 at Host device and the XMPP client 148 at the client device take care of XMPP related communication from both ends. The XMPP client 148 at client device 104 and a XMPP client 158 at the host device 105, send request to connect with XMPP server 102 with XMPP credentials such as user id, password in proper XMPP communication protocol format. Once the authenticity of the client device 104 and the host device 105 is verified by the XMPP server 102, the client device 104 and the host device 105 get connected with the XMPP server 102 for further communication. The XMPP client 148 and the XMPP client 158 may be responsible entities/layers for any communication through XMPP server over network. The client device or host device send a message to the XMPP server by using the XMPP clients and the XMPP server also forward the messages to the host device and the client device through the XMPP client at the client device and the host device.

A bidirectional secured communication channel is established between the client device 104 and the host device 105 as described above in paragraphs 0026 to 0032. The bidirectional secured communication channel is established by the XMPP server 102, between the client device 104 and the host device 105, using an Extensible Messaging and Presence Protocol (XMPP) or a network protocol, over a secured layer protocol. The communication between the client device 104 and the host device 105 is facilitated by the XMPP server 102, over the bidirectional secured communication channel.

The communication between the client device 104 and the host device 105 through the XMPP server 102 may be happening by means of an event driven architecture. The communication comprises establishing a remote communication session between the client device 104 and the host device 105. A client message handler 146 at client device side provides a client abstraction layer 414 to interpret and process, data or messages, sent and received during the remote communication session. Initialization of the remote communication session happens through the XMPP server 102 and the remote communication session may be authenticated and secured through an XMPP protocol over a Transport Layer Security (TLS) or a Secure Sockets Layer (SSL) protocol secured layer. The XMPP server 102 may verify a host network security and/or a firewall restriction. The communication happens through XMPP server 102 via the bidirectional secured communication channel established between the client device 104 and the host device 105. A host abstraction layer 412 at the host device 105 side may manage the communication at the host device side such as approving the request notification sent by the client device 104, rendering a display and executing events using an event driven architecture.

A client abstraction layer 414 at the client device 104 side may manage raising a request notification, displaying the host device screens located at remote location, simulating one or more control events at the client device, and sending simulated one or more control events to the host device 105 after required encoding for the simulated one or more control events over the bidirectional secured communication channel at corresponding protocols. A desktop or browser based application at the client device 104 side may make execution of the XMPP server 102 independent of technologies and platforms, hence the XMPP server 102 can be accessed using computer system, mobile devices or tablet.

The client abstraction layer 414 and the host abstraction layer 412 take care of data handling, wherein the data may be of different types. The client abstraction layer 414 and the host abstraction layer 412 enable features required to be available during remote communication session. Further based on the features, the client abstraction layer 414 and the host abstraction layer 412 load required plug-ins, publish and subscribe events at client device end and host device end. The events may be control events. The client abstraction layer 414 receives a request from the client device 104 through the client message handler 146 and performs appropriate action, approving or rejecting the request. At host end, the host abstraction layer 412 record screen changes, and calls to the host message handler 156 for further processing of screen data, and execute events, perform action, for the events sent and requested by the client device 104, during the remote communication session. The client abstraction layer 414 at the client device 104 raise a request, capture a control event, actions, simulate the control events, and call to the client message handler 146 for sending simulated control events to the host device 105. Further, the client abstraction layer 414 receives screen data from the host device 105 through the client message handler 146, merges the screen data and renders merged screen data to the client device 104 user interface.

Referring to FIG. 5-A and FIG. 5-B, the communication happening between the host device 105 and the client device 104 over the bidirectional secured communication channel is illustrated in accordance with an exemplary embodiment. In step 501, the host device 105 logs in to the XMPP server 102, using one or more XMPP credentials. In step 502, the client device 104 logs in to the XMPP server 102 using one or more XMPP credentials. In step 503, the client device 104 sends a request notification for establishing communication with the host device 105 and wait for response. The communication may be a remote communication. The remote communication may be through a remote communication session. In step 504, the host device may accept or reject the request notification of the client device 104. In step 505, the host device sends an acceptance notification or a rejection notification to the client device through the XMPP server 102. In step 506, the client device 104 receives a status of the request notification as approved or rejected by the host device 105. In one embodiment, in step 506, the client device 104 receives the acceptance notification or a rejection notification from the host device 105. If the request notification is accepted by the host device, in step 507, the client device 104 starts managing processes, user interface (UI) at the client device 104 accordingly.

If the request notification is accepted by the host device 105, in step 508, the host device 105 starts processes and establish a connection with the client device 104 over the bidirectional secured communication channel, and start communication with the client device 104 via the XMPP server 102. In one embodiment, the host device 105 may start the processes, to listen and tracking, for activities happening at the client device 104. The host device 105 may subscribe to various events based on features enabled during a remote communication session. The processes and the events at the host device 105 may work in integrated manner to provide enabled features to a user at the client device to give seamless experience of remote desktop controlling in real time manner. In step 510, the client device 104 synchs up and start the communication with the host device 105 via the XMPP server 102 based on the communication started by the host device in step 508.

In step 511, the host device 105 starts screen capture processes to capture the screen of the host device 105 itself. In step 512, the host device 105 starts sending the screen so captured to the client device 104. In step 513, the client device 104 receives data of the screen so captured, decode the data, and renders user interface (UI) of the host device 105 on the client device 104. In step 514, the host device 105 starts processes at the host device 105 for identifying changes in the screen due to user activities at the client device 104 and/or the host device 105, encoding the changes in the screen and sending changes in the screen back to the client device 104 for rendering the changes in the screen at the client device 104.

In step 515, the client device 104 receives changes in the screen sent by host device 105, decode the changes in the screen, merge the changes in the screen with the screen, and render the changes in the screen to the client device UI. In step 516, one or more events performed at the client device 104 end are simulated at the client device 104, and sent one or more simulated events to the host device 105 for execution of the one or more events performed at the client device 104 end.

In step 517, the host device receives one or more control events, decode and execute the one or more control events and/or clipboard at the host device 105 sent by the client device 104. In step 518, the processes at the host device 105 and in step 519 the processes at the client device communicate to each other during the remote communication session. In step 520, if the client device 104 is disconnected due to any reason, the client device 104 starts reconnecting the host device 105. In step 521, the host device 105 starts executing diagnostic services for identifying one or more issues in the remote communication. In step 522, the client device 104 may voluntarily finish and disconnect the remote communication with the host device 105 at any point of time. In step 522, the client device sends a request for termination of the remote communication to the host device 105. In step 523, the host device 105 stops processes and execute clean up of environment to release system memory and processor for further use.

According to an exemplary embodiment, event driven architecture for communication between the client device and the host device is described. XMPP client at both the device end (i.e. client and host) establishes connection with XMPP server and subscribes to message event, so whenever any message is sent to the client device from the XMPP server, message handler at client device gets triggered automatically. Client device gets notified and receives the message. The same process may continue using the messages and data until required by the client and host devices.

One or more events are published and subscribed at the client device to capture the user actions. So once user at the client device performs any action, appropriate event to the action gets triggered. The event is captured by an event handler, get simulated, get encoded and sent back to the host device through the XMPP server.

In similar manner various events at the host device are published and subscribed. Any action occurring at the host device due to a host end user or client simulated event is captured. Accordingly screen change event handler gets triggered once there is any action related to change in the screen. Screen change is encoded and sent back to the client device. Once message is received at client end, message event handler gets triggered and message event handler decodes the screen changes, and renders the screen changes at client device user interface (UI).

Example: If a client device 104 user performs some action such as mouse click on screen, mouse event handler gets triggered, mouse event gets simulated, encoded and encoded mouse event is sent to the XMPP server 102. The XMPP server 102 forwards the encoded mouse event to the host device 105 in message form. Once encoded mouse event is reached to the host device 105, host message event handler gets notified. The host message event handler decodes and executes the mouse click event at host end using the encoded mouse event so received. There may be changes in the state of controls and UI, so appropriate event handlers at the host device 105 end gets triggered. The appropriate event handlers simulate, encode screen changes and send the encoded screen changes back to the client device 104 through XMPP server 102. In this way event listeners at both device ends, Client device 104 and host device 105, handle the user actions in real time and communications becomes bidirectional and user friendly. The user at client device 104 feel same look of the host device 105, and feel as if he is sitting in front of the host device 105.

The event driven architecture used for communication between the client device 104 and the host device 105 avoids polling, and hence saves CPU cycles and achieves increased performance. Abstraction layers at client and host device (Host abstraction layer 412 and client abstraction layer 414) implement event based tracking and observation of the host device changes/actions. The events are defined or published at the host device end and the client device end, and the events are attached with an event queue for signaling and triggering purpose. The events are subscribed and attached with some methods, for example mouse event, keyboard event, audio, video related event and the like. When any signal comes, the abstraction layers (Host abstraction layer 412 and client abstraction layer 414) at the client device end and the host device end check a type of the signal, and match the type of the signal with the event queue to identify the event. After identifying the event, the abstractions layer (Host abstraction layer 412 and client abstraction layer 414) call to attached listener or methods. Thus appropriate method is called. Hence use of abstraction layers (Host abstraction layer 412 and client abstraction layer 414) avoid the CPU to check every time periodically, for any specific action to get happened, by using some dedicated separate thread.

The existing protocols used for establishing remote connectivity/communication, between client device and host device, have complex format of request and response messages, and follow many steps and lengthy processes during initialization of the remote communication and controlling session. On the contrary, in the present disclosure, an XMPP protocol is distributed and managed by the XMMP server. Further, use of the XMPP protocol simplifies remote communication processes. Due to simplification of the remote communication processes, any third party application can simply use and integrate the XMPP protocol in the present solutions.

Exemplary embodiments discussed above may provide certain advantages. Though not required to practice aspects of the disclosure, these advantages may include those provided by the following features.

Some embodiments enable a system and a method for sharing and controlling electronic devices located at remote locations using an Extensible Messaging and Presence Protocol (XMPP) server, wherein the electronic devices are protected under high security provisions or firewalls, and the electronic devices are not reachable and cannot communicate to each other directly.

Some embodiments enable a system and a method for sharing and controlling electronic devices located at remote locations through XMPP server by simplifying authentication of the electronic devices by using XMPP credentials provided by the XMPP server.

Some embodiments enable a system and a method for sharing and controlling electronic devices located at remote locations by establishing a bidirectional secured communication channel between a client device and a host device, using an Extensible Messaging and Presence Protocol (XMPP) or a network protocol, over a secured layer protocol, by the XMPP server.

Some embodiments enable a system and a method for ensuring security of data transmitted during communication over the network by the bidirectional secured communication channel between a client device and a host device, using an event driven architecture.

Some embodiments enable a system and a method for ensuring security of data transmitted during communication over the network by the bidirectional secured communication channel via an XMPP or a network protocol, over a TLS/SSL protocol.

Some embodiments enable a system and a method for sharing and controlling electronic devices located at remote locations protected under high security provisions by using XMPP server as a middleware for better remote communication by overcoming network boundary challenges.

Some embodiments enable a system and a method for sharing and controlling electronic devices located at remote locations when any of the electronic devices is disconnected, data of communication is kept on the XMPP server and once the electronic device is available, the data is shared with the electronic device based on an event driven approach.

Some embodiments enable a system and a method for providing chat, interaction and messaging between the electronic devices located at remote locations.

Some embodiments enable a system and a method for using an event driven approach to avoid polling and hence saving CPU cycles and achieving increased performance.

Some embodiments enable a system and a method can be implemented and executed in a platform independent manner.

Some embodiments enable a system and method to be used and implemented irrespective of tools, technologies and platforms.

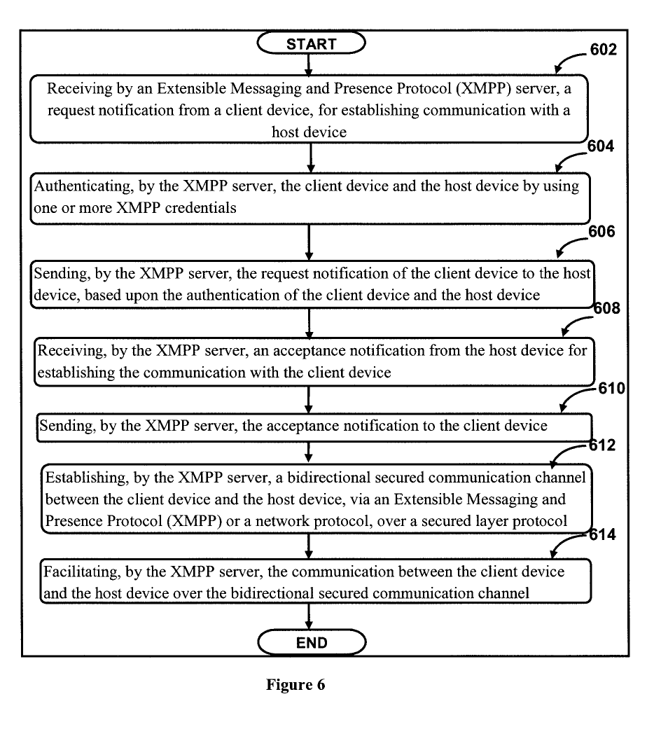

Referring now to FIG. 6, a method 600 for sharing and controlling electronic devices located at remote locations is shown, in accordance with an embodiment of the present subject matter. The electronic devices may be one or more client devices and one or more host devices. The electronic devices may comprise a variety of electronic devices. The electronic devices may comprise a variety of computing systems, such as a laptop computer, a desktop computer, a notebook, a workstation, a mainframe computer, a network server, a mobile device, a portable computer, a tablet, and the like. The electronic devices may be any electronic device known to a person skilled in the art. The method 600 may be described in the general context of computer executable instructions. Generally, computer executable instructions can include routines, programs, objects, components, data structures, procedures, modules, functions, etc., that perform particular functions or implement particular abstract data types. The method 600 may also be practiced in a distributed computing environment where functions are performed by remote processing devices that are linked through a communications network. In a distributed computing environment, computer executable instructions may be located in both local and remote computer storage media, including memory storage devices.

The order in which the method 600 is described is not intended to be construed as a limitation, and any number of the described method blocks can be combined in any order to implement the method 600 or alternate methods. Additionally, individual blocks may be deleted from the method 600 without departing from the spirit and scope of the subject matter described herein. Furthermore, the method can be implemented in any suitable hardware, software, firmware, or combination thereof. However, for ease of explanation, in the embodiments described below, the method 600 may be considered to be implemented in the above described system 102.

At block 602, a request notification may be received from a client device, by an Extensible Messaging and Presence Protocol (XMPP) server, for establishing a communication with a host device. The communication may be a remote communication. The remote communication may happen through a remote communication session. In one implementation, the request notification may be received from the client device, by the Extensible Messaging and Presence Protocol (XMPP) server 102, for establishing the communication with the host device. The client device and host device may be connected under secured network. The client device and host device may be restricted to access each other through firewall restricted boundaries. The client device and the host device may not have a public IP address or a public identification number, and hence the client device and the host device may be invisible to external devices.

At block 604, the client device and the host device may be authenticated by the XMPP server, by using one or more XMPP credentials. In one implementation, the client device 104 and the host device 105 may be authenticated by the XMPP server 102, by using the one or more XMPP credentials. The one or more XMPP credentials may comprise internal identification number or Internet Protocol (IP) address, and the XMPP server may facilitate the communication between the client device 104 and the host device 105 using the one or more XMPP credentials.

At block 606, the request notification of the client device may be sent to the host device, by the XMPP server, based upon the authentication of the client device. In one implementation, the request notification of the client device 104 may be sent to the host device 105, by the XMPP server 102, based upon the authentication of the client device 104.

At block 608, an acceptance notification may be received from the host device by the XMPP server for establishing the communication with the client device. In one implementation, the acceptance notification may be received from the host device 105 by the XMPP server 102 for establishing the communication with the client device 104.

At block 610, the acceptance notification may be sent to the client device by the XMPP server. In one implementation, the acceptance notification may be sent to the client device 104 by the XMPP server 102.

At block 612, a bidirectional secured communication channel may be established between the client device and the host device, via an Extensible Messaging and Presence Protocol (XMPP) or a network protocol, over a secured layer protocol, by the XMPP server. In one implementation, the bidirectional secured communication channel may be established between the client device 104 and the host device 105, via an Extensible Messaging and Presence Protocol (XMPP) or a network protocol, over a secured layer protocol, by the XMPP server of the system 102. The network protocol may be selected from Transmission a Control Protocol (TCP) or an Internet Protocol (IP). The secured layer protocol may be selected from a Transport Layer Security (TLS) or a Secure Sockets Layer (SSL) protocol. The establishing of the bi-directional secured communication channel may comprise, using a client abstraction layer of the client device and a host abstraction layer of the host device, to load plug-ins for XMPP protocol, and wherein the client abstraction layer and the host abstraction layer handles rendering a remote display and transporting an event for the client device and the host device using event driven approach.

At block 614, the communication between the client device and the host device, over the bidirectional secured communication channel, may be facilitated by the XMPP server. In one implementation, the communication between the client device and the host device, over the bidirectional secured communication channel, may be facilitated by the XMPP server 102.

The method 600 further comprises executing the communication between the client device and the host device over the bidirectional secured communication channel, using the Extensible Messaging and Presence Protocol (XMPP) or the network protocol, over the secured layer protocol. The communication may further comprise, receiving a screen from the host device by the client device. The communication may further comprise decoding the screen and rendering the screen on a user interface by the client device. The communication may further comprise receiving a change in the screen from the host system by the client device. The communication may further comprise decoding the change in the screen and merging the change in the screen to generate an updated screen, by the client device. The communication may further comprise rendering the updated screen on the user interface by the client device. The communication may further comprise capturing and simulating, at least one of one or more control events and clipboard, by the client device. The communication may further comprise encoding the at least one of one or more control events and clipboard, by the client device and sending encoded the at least one of one or more control events and clipboard to the host device, by the client device. A client abstraction layer provided by a client message handler 146 at the client device may handle tasks such as receiving a screen, receiving the change in the screen, and sending encoded the at least one of one or more control events and clipboard.

The communication may further comprise capturing a screen by the host device and encoding captured screen by the host device. The communication may further comprise sending the encoded screen to the client device, by the host device. The communication may further comprise capturing changes in the screen by the host device and encoding the changes in the screen by the host device. The communication may further comprise sending encoded changes in the screen to the client device by the host device.

The communication may further comprise receiving encoded at least one of one or more control events and clipboard from the client device, by the host device. The communication may further comprise executing received at least one of one or more control events and clipboard by the host device. A host abstraction layer provided by a host message handler 156 at the host device may handle tasks such as sending the encoded screen to the client device, sending encoded changes in the screen to the client device, and receiving encoded at least one of one or more control events and clipboard from the client device. In one implementation, the communication may be happening in the client device 104 and the host device 105 through the XMPP server 102 as described above.

Although implementations for methods and systems for sharing and controlling electronic devices located at remote locations have been described in language specific to structural features and/or methods, it is to be understood that the appended claims are not necessarily limited to the specific features or methods described. Rather, the specific features and methods are disclosed as examples of implementations for sharing and controlling the electronic devices located at remote locations.

We claim:

1. A method for sharing and controlling electronic devices located at remote locations, the method comprising:
receiving, by an Extensible Messaging and Presence Protocol server, a request notification from a client device, for establishing communication with a host device;
authenticating, by the Extensible Messaging and Presence Protocol server, the client device and the host device by using one or more Extensible Messaging and Presence Protocol credentials;
sending, by the Extensible Messaging and Presence Protocol server, the request notification of the client device to the host device, based upon the authentication of the client device and the host device;
receiving, by the Extensible Messaging and Presence Protocol server, an acceptance notification from the host device for establishing the communication with the client device;
sending, by the Extensible Messaging and Presence Protocol server, the acceptance notification to the client device;
establishing, by the Extensible Messaging and Presence Protocol server, a bidirectional secured communication channel between the client device and the host device, using an Extensible Messaging and Presence Protocol or a network protocol, over a secured layer protocol; and
facilitating, by the Extensible Messaging and Presence Protocol server, the communication between the client device and the host device over the bidirectional secured communication channel.

2. The method of claim 1, wherein the network protocol is selected from Transmission Control Protocol or an Internet Protocol.

3. The method of claim 1, wherein the secured layer protocol is selected from a Transport Layer Security or a Secure Sockets Layer protocol.

4. The method of claim 1, wherein the client device and host device are connected under secured network, and the client device and host device are restricted to access each other through firewall restricted boundaries.

5. The method of claim 1, wherein the client device and the host device lack a public IP address or a public identification number, and the client device and the host device is invisible to external devices.

6. The method of claim 1, wherein the one or more Extensible Messaging and Presence Protocol credentials comprises internal identification number or Internet Protocol (IP) address, and the Extensible Messaging and Presence Protocol server facilitates the communication between the client device and the host device using the one or more Extensible Messaging and Presence Protocol credentials.

7. The method of claim 1, wherein establishing the bidirectional secured communication channel comprises using a client abstraction layer and a host abstraction layer, to load plug-ins for Extensible Messaging and Presence Protocol protocol, and wherein the client abstraction layer and the host abstraction layer handle rendering a remote display and transporting an event for the client device and the host device respectively.

8. The method of claim 1, wherein the communication is happening by means of an event driven architecture, and communication the further comprises,
receiving a screen from the host device by the client device;
decoding the screen and rendering the screen on a user interface by the client device;
receiving a change in the screen from the host system by the client device;
decoding the change in the screen and merging the change in the screen to generate an updated screen, by the client device; and
rendering the updated screen on the user interface by the client device.

9. The method of claim 8 further comprises,
capturing and simulating, at least one of one or more control events and clipboard, by the client device;
encoding the at least one of one or more control events and clipboard, by the client device; and
sending encoded the at least one of one or more control events and clipboard to the host device, by the client device.

10. The method of claim 9, wherein receiving the screen, receiving the change in the screen, and sending encoded at least one of one or more control events and clipboard are handled by a client message handler at the client device.

11. The method of claim 1, wherein the communication is happening by means of an event driven architecture, and communication the further comprises,
capturing a screen by the host device;
encoding captured screen by the host device;
sending the encoded screen to the client device, by the host device.
capturing changes in the screen by the host device;
encoding the changes in the screen by the host device;
sending encoded changes in the screen to the client device by the host device.

12. The method of claim 11 further comprises,
receiving encoded at least one of one or more control events and clipboard from the client device, by the host device;
executing received at least one of one or more control events and clipboard by the host device.

13. The method of claim 12, wherein sending the encoded screen to the client device, sending encoded changes in the screen to the client device, and receiving encoded at least one of one or more control events and clipboard from the client device are handled by a host message handler at the host device.

14. An Extensible Messaging and Presence Protocol server for sharing and controlling electronic devices located at remote locations, the Extensible Messaging and Presence Protocol server comprising:
a processor; and
a memory coupled to the processor, wherein the processor is capable of executing programmed instructions stored in the memory to:
receive a request notification from a client device, for establishing communication with a host device;
authenticate the client device and the host device using Extensible Messaging and Presence Protocol credentials;
sending, the request notification of the client device to the host device based upon the authentication of the client device and the host device;
receive an acceptance notification from the host device for establishing the communication with the client device;
send the acceptance notification with the client device;
establish a bidirectional secured communication channel between the client device and the host device, via an Extensible Messaging and Presence Protocol protocol or a network protocol, over a secured layer protocol; and
facilitate the communication between the client device and the host device over the bidirectional secured communication channel.

15. The Extensible Messaging and Presence Protocol server of claim 14, wherein the client device and host device are connected under secured network and the client device and host device are restricted to access each other through firewall restricted boundaries.

16. The Extensible Messaging and Presence Protocol server of claim 14, wherein the client device and the host device are not having a public IP address or a public identification number and the client device and the host device are invisible to external systems.

17. A client device communicating with a host device located at remote locations, through an Extensible Messaging and Presence Protocol XMPP server, the client device comprising:
a client processor; and
a client memory coupled to the client processor, wherein the client processor is capable of executing programmed instructions stored in the client memory to:
send, a request notification, to the XMPP server for establishing communication with the host device, by using a client message handler;
receive, an acceptance notification from the XMPP server for establishing the communication with the host device, by using the client message handler; and
communicate with the host device over a bidirectional secured communication channel established with the host device, using an XMPP protocol or a network protocol, over a secured layer protocol, by the XMPP server.

18. The client device of claim 17, wherein the network protocol is selected from Transmission a Control Protocol or an Internet Protocol.

19. The client device of claim 17, wherein the secured layer protocol is selected from a Transport Layer Security or a Secure Sockets Layer protocol.

20. The client device of claim 17, wherein the client device and host device are connected under secured network, and the client device and host device are restricted to access each other through firewall restricted boundaries.

21. The client device of claim 17, wherein the processor is further capable of executing programmed instructions stored in the memory to:
receive a screen from the host device over the bidirectional secured communication channel;
decoding the screen and rendering the screen on a user interface;
receiving a change in the screen from the host device over the bidirectional secured communication channel;
decoding the change in the screen and merging the change in the screen to generate an updated screen; and
rendering the updated screen on the user interface.

22. The client device of claim 17, wherein the processor is further capable of executing programmed instructions stored in the memory to:
capture and simulate, at least one of one or more control events and clipboard;
encoding the at least one of one or more control events and clipboard; and
sending encoded the at least one of one or more control events and clipboard to the host device over the bidirectional secured communication channel.

23. A host device communicating with a client device located at remote location, through an Extensible Messaging and Presence Protocol server, the system comprising:
a host processor; and
a host memory coupled to the host processor, wherein the host processor is capable of executing programmed instructions stored in the host memory to:
receive a request notification from the Extensible Messaging and Presence Protocol server for establishing communication with the client device, by using a host message handler;
send an acceptance notification to the Extensible Messaging and Presence Protocol server for establishing the communication with the client device, by using the host message handler; and
communicate with the client device over a bidirectional secured communication channel established with the host device, using an Extensible Messaging and Presence Protocol protocol or a network protocol, over a secured layer protocol, by the Extensible Messaging and Presence Protocol server.

24. The host device of claim 23, wherein the network protocol is selected from Transmission a Control Protocol or an Internet Protocol.

25. The host device of claim 23, wherein the secured layer protocol is selected from a Transport Layer Security or a Secure Sockets Layer protocol.

26. The host device of claim 23, wherein the client device and the host device are connected under secured network, and the client device and the host device are restricted to access each other through firewall restricted boundaries.

27. The host device of claim 23, wherein the processor is further capable of executing programmed instructions stored in the memory to:
capture a screen;
encode captured screen;
send the encoded screen to the client device over the bidirectional secured communication channel;
capture changes in the screen;
encode the changes in the screen;
send encoded changes in the screen to the client device over the bidirectional secured communication channel.

28. The host device of claim 23, wherein the processor is further capable of executing programmed instructions stored in the memory to:
receive encoded at least one of one or more control events and clipboard from the client device over the bidirectional secured communication channel;
execute received at least one of one or more control events and clipboard.
